(19) United States
(12) Patent Application Publication
(10) Pub. No.: US 2026/0161710 A1
(43) Pub. Date: Jun. 11, 2026

(54) CONTEXT SENSITIVE WORD PREDICTION

(71) Applicant: Uma Umesh Gajendragadkar, Renton, WA (US)

(72) Inventor: Uma Umesh Gajendragadkar, Renton, WA (US)

(21) Appl. No.: 18/972,434

(22) Filed: Dec. 6, 2024

(51) Int. Cl. G06F 16/9032; G06F 16/2457

(52) U.S. Cl. CPC G06F 16/90328; G06F 16/24578

(57) ABSTRACT

Systems and methods provide context-sensitive word prediction for partial search inputs using multiple datasets. In one embodiment, the system receives a search prefix and accesses a plurality of datasets, including a temporal contextual dataset, a statistical n-gram dataset, and a semantic dataset. The system assigns a weight to each dataset based on a predefined hierarchy, giving higher priority to contextually relevant data. Using the assigned weights, the system generates a list of keyword suggestions by interpolating results from the datasets. Duplicate suggestions are filtered out, and the total number of suggestions is constrained to a predefined maximum. The system then displays the generated keyword suggestions in real-time or near-real-time as the user continues to input the search prefix, enhancing the efficiency and contextual accuracy of the search experience.

### TECHNICAL FIELD

Implementations relate generally to predictive text techniques. More specifically, implementations relate to methods and systems for predicting word completions in search interfaces with weighted interpolation to provide relevant keyword suggestions.

### BACKGROUND

Search engines, mobile devices, and various software applications frequently use word completion algorithms to improve the efficiency of user input. Traditionally, such systems rely on analyzing a partial input from a user, matching it against stored datasets, and predicting possible word completions or search queries. These systems aim to reduce the number of keystrokes a user must enter to arrive at the desired result, thereby improving the overall user experience. In early implementations, these systems would primarily rely on static datasets, such as previously searched queries or popular keywords. However, the predictive accuracy of these systems was often limited by the outdated or contextually irrelevant nature of the data being used.

Some more advanced approaches attempt to incorporate context into word prediction, using data from past search logs or session-based data, such as queries entered during the current search session. These methods provide a more relevant set of keyword completions by focusing on recent user behavior. However, they still fail to account for dynamic, real-world changes such as recent news events or seasonal contexts that could significantly alter the intent of the user. Moreover, the use of static corpora such as session-based logs often leads to keyword suggestions that are not personalized or timely, limiting their usefulness in rapidly changing environments.

Consequently, there is a need in the art for more sophisticated methods and systems that can dynamically predict word completions by integrating real-time or near-real-time contextual data, statistical datasets, and semantic relationships, enabling more accurate, contextually relevant keyword suggestions.

### SUMMARY

The appended claims may serve as a summary of this application.

### BRIEF DESCRIPTION OF THE DRAWINGS

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2 is a flowchart illustrating an exemplary method that may be performed in some embodiments.

FIG. 3 is a flowchart illustrating a process for generating contextual data, in accordance with some embodiments.

FIG. 4 illustrates an overview of an example process for context sensitive word prediction, in accordance with some embodiments.

FIG. 5 illustrates an example process for mining keywords from corpora, in accordance with some embodiments.

FIG. 6 presents an example process for context-sensitive word prediction, in accordance with some embodiments.

FIG. 7 depicts a context taxonomy that categorizes various thematic areas in which keywords can be classified, in accordance with some embodiments.

FIG. 8 illustrates an example of the autocomplete feature generated by the context-sensitive word prediction process, in accordance with some embodiments.

FIG. 9 is a diagram illustrating an exemplary computer that may perform processing in some embodiments.

### DETAILED DESCRIPTION

In this specification, reference is made in detail to specific embodiments of the disclosure.

For clarity in explanation, the disclosure has been provided with reference to specific embodiments, however it should be understood that the disclosure is not limited to the described embodiments. On the contrary, the disclosure covers alternatives, modifications, and equivalents as may be included within its scope as defined by any patent claims. The following embodiments of the disclosure are set forth without any loss of generality to, and without imposing limitations on, the disclosure. In the following description, specific details are set forth in order to provide a thorough understanding of the present disclosure. The present disclosure may be practiced without some or all of these specific details. In addition, well known features may not have been described in detail to avoid unnecessarily obscuring the disclosure.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

In one embodiment, the system receives a search prefix and accesses a plurality of datasets, including a temporal contextual dataset, a statistical n-gram dataset, and a semantic dataset. The system assigns a weight to each dataset based on a predefined hierarchy, giving higher priority to contextually relevant data. Using the assigned weights, the system generates a list of keyword suggestions by interpolating results from the datasets. Duplicate suggestions are filtered out, and the total number of suggestions is constrained to a predefined maximum. The system then displays the generated keyword suggestions in real-time or near-real-time as the user continues to input the search prefix, enhancing the efficiency and contextual accuracy of the search experience.

Further areas of applicability of the present disclosure will become apparent from the remainder of the detailed description and the claims. The detailed description and specific examples are intended for illustration only and are not intended to limit the scope of the disclosure.

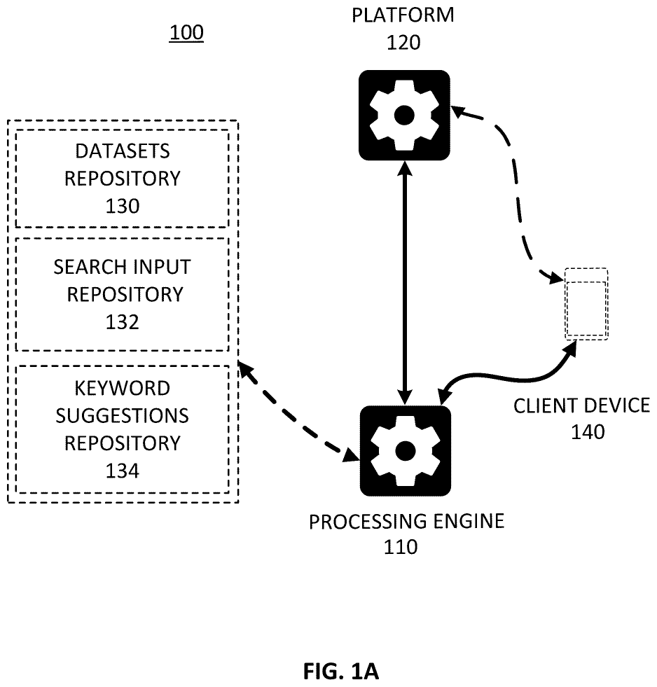

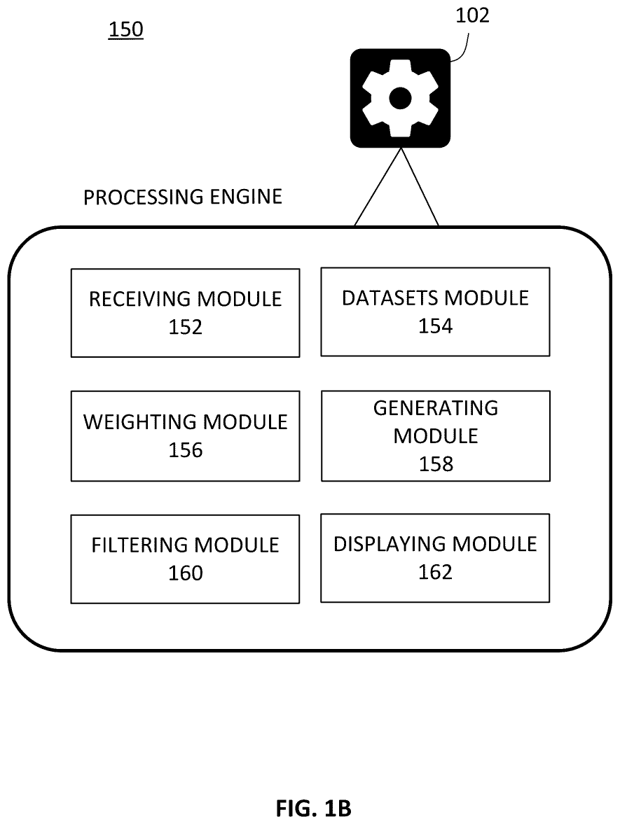

FIG. 1A is a diagram illustrating an exemplary environment in which some embodiments may operate. In the exemplary environment 100, a client device 140 is connected to a processing engine 110 and, optionally, a platform 120. The processing engine 110 is connected to the platform 120, and optionally connected to one or more repositories and/or databases, including, e.g., a datasets repository 130, a search input repository 132, and/or a keyword suggestions repository 134. One or more of the databases may be combined or split into multiple databases. The client device 140 in this environment may be a computer, and the platform 120 and processing engine 110 may be applications or software hosted on a computer or multiple computers which are communicatively coupled via remote server or locally.

The exemplary environment 100 is illustrated with only one client device, one processing engine, and one platform, though in practice there may be more or fewer additional client devices, processing engines, and/or platforms. In some embodiments, the client device(s), processing engine, and/or platform may be part of the same computer or device.

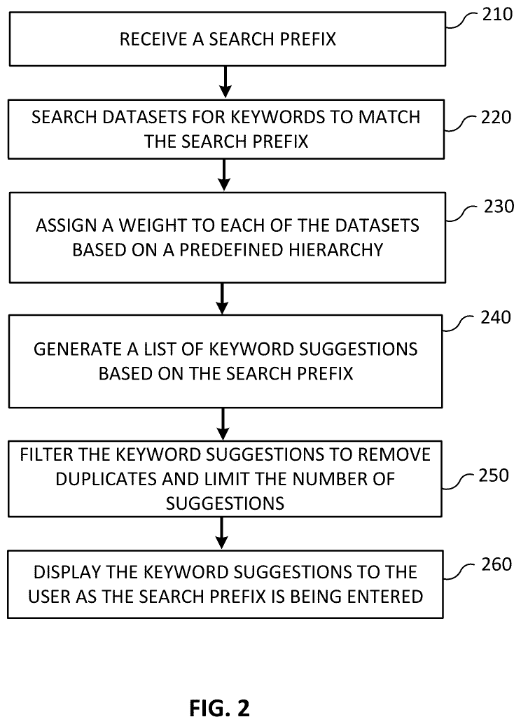

In an embodiment, the processing engine 110 may perform the exemplary method of FIG. 2 or other method herein and, as a result, provide context sensitive word prediction in search interfaces. In some embodiments, this may be accomplished via communication with the client device, processing engine, platform, and/or other device(s) over a network between the device(s) and an application server or some other network server. In some embodiments, the processing engine 110 is an application, browser extension, or other piece of software hosted on a computer or similar device, or is itself a computer or similar device configured to host an application, browser extension, or other piece of software to perform some of the methods and embodiments herein.

The client device 140 is a device with a display configured to present information to a user of the device who is a user of the platform 120. In some embodiments, the client device presents information in the form of a visual UI with multiple selectable UI elements or components. In some embodiments, the client device 140 is configured to send and receive signals and/or information to the processing engine 110 and/or platform 120. In some embodiments, the client device is a computing device capable of hosting and executing one or more applications or other programs capable of sending and/or receiving information. In some embodiments, the client device may be a computer desktop or laptop, mobile phone, virtual assistant, virtual reality or augmented reality device, wearable, or any other suitable device capable of sending and receiving information. In some embodiments, the processing engine 110 and/or platform 120 may be hosted in whole or in part as an application or web service executed on the client device 140. In some embodiments, one or more of the platform 120, processing engine 110, and client device 140 may be the same device. In some embodiments, the client device 140 is associated with a first user account within a platform, and one or more additional client device(s) may be associated with additional user account(s) within the platform.

In some embodiments, optional repositories can include a datasets repository 130, search input repository 132, and/or keyword suggestions repository 134. The optional repositories function to store and/or maintain, respectively, information from various datasets; search inputs from users; and generated keyword suggestions. The optional database(s) may also store and/or maintain any other suitable information for the processing engine 110 or platform 120 to perform elements of the methods and systems herein. In some embodiments, the optional database(s) can be queried by one or more components of system 100 (e.g., by the processing engine 110), and specific stored data in the database(s) can be retrieved.

Platform 120 is a platform configured for providing a search engine to a user, and further configured for context sensitive word prediction. The platform 120 may present a user with one or more user interfaces or interface components which facilitate the submission of user information and data.

FIG. 1B is a diagram illustrating an exemplary computer system 140 with software modules that may execute some of the functionality described herein. In some embodiments, the modules illustrated are components of the processing engine 110.

Receiving module 152 functions to receive, at a processing system, a search prefix entered by a user in a search interface.

Datasets module 154 functions to search a number of datasets for keywords that match the search prefix.

Weighting module 156 functions to assign a weight to each of the datasets based on a predefined hierarchy.

Generating module 158 functions to generate a list of keyword suggestions based on the search prefix by interpolating results from the datasets according to the assigned weights.

Filtering module 160 functions to filter the keyword suggestions to remove duplicates and limit the number of suggestions to a predefined maximum number.

Displaying module 162 functions to display the keyword suggestions to the user in real-time or near-real-time as the search prefix is being entered.

The above modules and their functions will be described in further detail in relation to an exemplary method below.

FIG. 2 is a flowchart illustrating an exemplary method that may be performed in some embodiments.

At step 210, the system receives, at a processing system, a search prefix entered by a user in a search interface. A search prefix refers to the initial segment of a word, phrase, or query that is partially entered into an input field by the user. For example, if the user begins typing “elec”, this incomplete input represents the search prefix. The system processes this prefix before the user completes the intended word or phrase.

The term “user” refers to any individual or entity interacting with the system by entering search terms, queries, or other forms of input via an interface. In various embodiments, the user may engage with the system through various devices, including but not limited to personal computers, mobile phones, tablets, or other electronic devices capable of handling text input. Users may have varying intents when entering a search prefix, which the system is designed to interpret through subsequent steps.

The search interface is any component or user interface that allows a user to input data for the purpose of generating search results or other predictions. In various embodiments, this interface could be, for example, a search bar on a search engine, a text input field in a mobile application, or any other user interface that accepts text input. The search interface is connected to a processing system, which is responsible for receiving and processing the search prefix. The interface captures the input of the user, character by character, and transmits the information to the system in real-time or near-real-time.

In some embodiments, upon receiving the search prefix at the processing system, the data is temporarily stored in memory for immediate use by the word prediction algorithm. The processing system may include one or more processors and memory units that handle incoming data from the search interface. In some embodiments, the received search prefix triggers the system's word prediction functionality, which involves searching through multiple datasets to generate suggestions based on the partial input. In some embodiments, the processing system continuously listens for input from the search interface, updating its internal processes as new characters are entered.

At step 220, the system searches datasets for keywords that match the search prefix. In this context, a dataset refers to a structured collection of data, typically organized into records or files, that the system can access and search for specific information. These datasets may include, but are not limited to, collections of previously used search terms, curated lists of words, or any other predefined collections of linguistic data. The search operation is designed to return relevant keywords that begin with or match the search prefix provided by the user.

The term keyword in this context refers to a complete word or phrase that the system identifies as a potential completion for the search prefix. For example, if the user enters the search prefix “elec,” the system may search the datasets for keywords such as “electric,” “electricity,” or “electronic.” Keywords are typically stored in the datasets as discrete entries, with each entry representing a distinct word or phrase. These keywords are processed by the system to identify potential matches based on the characters that have been entered by the user.

The system performs a comparison between the search prefix and the keywords stored in the datasets. In some embodiments, this comparison involves checking whether the prefix entered by the user matches the initial characters of any keywords within the dataset. In some embodiments, the comparison may be performed using string-matching techniques, which allow the system to evaluate whether the sequence of characters in the search prefix is the same as the beginning portion of any stored keyword. If a match is found, the system adds that keyword to the list of potential completions that will be generated later in the process.

In various embodiments, the search process may involve querying multiple datasets simultaneously or sequentially, depending on the system's configuration. In some implementations, the system may search different types of datasets, each containing distinct categories of data. These datasets may vary in terms of their size, structure, and the type of information they contain. For example, one dataset may consist of static entries, while another could be dynamically updated. Regardless of the type, the search function operates uniformly, aiming to locate keywords that match the search prefix with precision.

In some embodiments, the datasets include a temporal contextual dataset that includes dynamic data related to current events and season-based keyword data. In some embodiments, the temporal contextual dataset is constructed by collecting and processing data that reflects the current time period, such as, e.g., ongoing news, social trends, or events specific to the current calendar month or season. For example, during an election period, the dataset may dynamically incorporate keywords related to political events, candidates, and campaigns. Similarly, during the holiday season, the dataset may include season-based keywords such as “Christmas,” “holiday shopping,” or “New Year.” This dynamic nature of the dataset allows it to continuously update as new events occur, ensuring that the system's keyword suggestions remain contextually relevant to the user's current environment. The temporal contextual dataset may be periodically refreshed, using techniques such as RSS feed parsing or external data scraping, to maintain its relevance and accuracy in relation to real-world developments.

In some embodiments, the temporal contextual dataset includes real-time or near-real-time news feed data parsed and tokenized from an RSS feed. The system retrieves the RSS feed, which contains updates on current events, and parses it to extract relevant information, such as article titles and summaries. This parsed data is then tokenized, breaking down the text into individual keywords or tokens, while removing stopwords and standardizing the keywords. For example, a headline like “Electric Car Sales Surge in 2024” would be split into tokens such as “electric,” “car,” “sales,” “surge,” and “2024.” These tokens are added to the temporal contextual dataset, ensuring that the system continuously reflects the latest news and trends in its keyword suggestions. This real-time or near-real-time integration allows the system to provide relevant keyword completions based on dynamic, up-to-date information from ongoing events.

In some embodiments, the temporal contextual dataset includes keywords related to specific occasions associated with the current calendar period. These keywords are pre-defined and correspond to events or holidays that are relevant to a particular time of year. For example, during the month of December, the dataset may include keywords such as “Christmas,” “holiday shopping,” and “New Year.” Similarly, in the month of February, the dataset might contain keywords like “Valentine's Day” or “Super Bowl.” These occasion-based keywords are dynamically added to the dataset based on the current calendar period, allowing the system to provide keyword suggestions that align with seasonal or event-based contexts relevant to the user's search intent during that time.

In some embodiments, the datasets additionally include a statistical n-gram dataset that includes n-gram keywords. An n-gram refers to a contiguous sequence of n items, typically words or characters, extracted from a given text or speech data. In the context of this dataset, n-gram keywords are sequences of one or more words, where the “n” indicates the number of words in each sequence. For example, a 1-gram consists of a single word like “electric,” while a 2-gram could be a phrase such as “electric car.” These n-grams are statistically generated by analyzing large volumes of text data to identify the most frequently occurring sequences. The statistical n-gram dataset is used to predict likely keyword completions based on common word usage patterns.

In some embodiments, the datasets additionally include a semantic dataset that includes lexical and semantic relationships between words. A semantic dataset is a structured collection of data that captures the meanings of words and the relationships between them, such as synonyms, antonyms, and hierarchical relationships. This dataset leverages lexical databases to understand not only the literal definitions of words but also how they relate to one another in terms of meaning. For example, the word “electricity” might be linked to words like “power,” “energy,” or “current” due to their semantic proximity. The semantic dataset allows the system to provide more contextually accurate keyword suggestions by considering words that may not directly match the search prefix but are closely related in meaning.

At step 230, the system assigns a weight to each of the datasets based on a predefined hierarchy. In some embodiments, a temporal contextual dataset is assigned a higher weight than a statistical n-gram dataset and a semantic dataset. The term weight refers to a numerical value or coefficient that reflects the relative importance of a particular dataset during the keyword suggestion process. This weighting system allows the processing system to prioritize certain datasets over others when generating keyword completions. The assigned weight directly affects how much influence each dataset has on the final list of suggested keywords, with higher weights leading to greater influence in the interpolation process.

In some embodiments, the predefined hierarchy of weights is established based on the relevance and timeliness of the datasets in relation to the user's input. In some embodiments, the temporal contextual dataset is assigned the highest weight. This dataset contains dynamic, real-time or near-real-time information related to current events, news, and season-specific keywords, which are likely to change frequently and have immediate relevance to the user's intent. For example, if a user begins entering the prefix “election,” the temporal contextual dataset, which contains information about current elections, would be prioritized. By assigning a higher weight to this dataset, the system increases the likelihood that keywords related to current events will appear at the top of the suggested completions.

In some embodiments, the statistical n-gram dataset is assigned a lower weight than the temporal contextual dataset, but it still plays a significant role in the word prediction process. This dataset contains n-gram sequences that represent common word patterns derived from large-scale text data. Since n-grams are based on statistical analysis of language usage, they provide a reliable source of information on how words typically co-occur in various contexts. Although not as time-sensitive as the temporal contextual dataset, the n-gram data helps the system account for frequent and predictable patterns in user input. By assigning a medium weight to this dataset, the system ensures that these patterns influence keyword suggestions while not overriding more relevant real-time or near-real-time data.

In some embodiments, the semantic dataset is assigned the lowest weight in the hierarchy. This dataset focuses on lexical and semantic relationships between words, such as synonyms, antonyms, and related concepts. While this information is valuable for generating contextually relevant suggestions, it is less directly tied to real-time or near-real-time events or statistical language patterns. For instance, if a user types “power,” the semantic dataset may suggest words like “energy” or “electricity” based on meaning, but these suggestions may not always reflect the user's immediate intent. Assigning the lowest weight to the semantic dataset ensures that while semantic relationships are considered, they do not dominate the keyword suggestions unless no suitable matches are found in the higher-weighted datasets.

In some embodiments, the system dynamically adjusts the weight assigned to each dataset based on user-specific context, which may include one or more factors such as the user's location, language, or search history. For example, if the user is located in a specific region, the system may increase the weight of the temporal contextual dataset to prioritize keywords relevant to local events or news. Similarly, the system can adjust the weights based on the user's preferred language, ensuring that keyword suggestions align with linguistic preferences. In some embodiments, the system may consider the user's past search history to further refine the weighting, prioritizing datasets that have previously resulted in more relevant or accurate suggestions.

At step 240, the system generates a list of keyword suggestions based on the search prefix by interpolating results from the datasets according to the assigned weights. A keyword suggestion refers to a word or phrase that is proposed by the system as a potential completion of the search prefix entered by the user. This list of suggestions is compiled by analyzing and combining the relevant data from the temporal contextual dataset, the statistical n-gram dataset, and the semantic dataset. The interpolation process ensures that the suggestions are influenced proportionally by the relevance of each dataset, as determined by the previously assigned weights.

The process of interpolation refers to combining or integrating data from multiple sources, in this case, the three datasets, to form a cohesive and ranked list of keyword suggestions. The system evaluates the results returned from each dataset individually, applies the assigned weight to each result, and combines the weighted results into a unified set of suggestions. For example, if a search prefix matches a keyword in both the temporal contextual dataset and the n-gram dataset, but the temporal dataset is weighted higher, that match will carry more influence in the final list.

In some embodiments, the system may generate more keyword suggestions than can be displayed or processed immediately, so a ranking mechanism is employed to order the suggestions based on their weighted relevance. During interpolation, results from the dataset with the highest weight, typically the temporal contextual dataset, will be ranked higher on the list of keyword suggestions. Lower-ranked suggestions may still appear on the list, but they will have less influence unless they are particularly strong matches from other datasets. This ranking allows the system to present the most relevant keyword completions to the user, based on the context provided by the datasets.

In some embodiments, once the interpolation process is complete, the system compiles the ranked list of keyword suggestions and prepares it for display. The length of the list is typically limited to a predefined maximum number, which ensures that only the most relevant suggestions are presented to the user in a concise format. The generation of the keyword suggestion list is a critical step in providing real-time or near-real-time feedback to the user as they continue to enter additional characters into the search interface. As the search prefix is updated with each new character, the system dynamically regenerates the list of keyword suggestions by repeating the interpolation process based on the evolving input.

In some embodiments, the system presents the keyword suggestions in a ranked order based on their relevance to the temporal context. The ranking process evaluates each suggestion against the temporal contextual dataset, which contains data related to current events, trends, or seasonal keywords. Suggestions that are more closely aligned with the current time period or ongoing events are ranked higher on the list. For example, during a major sporting event, keywords related to that event would appear at the top of the suggestions list. This ranking ensures that users are presented with the most contextually relevant completions first, improving the likelihood that the suggested keywords match the user's current intent.

In some embodiments, the system caches the keyword suggestions for quicker retrieval in response to subsequent keypresses. Caching refers to the temporary storage of data in memory to facilitate faster access in future operations. After generating an initial list of keyword suggestions based on a user's search prefix, the system stores these suggestions in a cache. As the user continues typing, the cached suggestions are quickly retrieved and updated, reducing the need for the system to reprocess the same data from the datasets. This approach improves the system's responsiveness, allowing it to display updated keyword suggestions with minimal latency as the search prefix evolves with each new keypress.

In some embodiments, the cached keyword suggestions are updated periodically based on changes in the temporal contextual dataset. As the temporal contextual dataset incorporates dynamic data such as real-time or near-real-time news and seasonal keywords, the cache must reflect these updates to maintain the relevance of keyword suggestions. The system periodically checks for new or modified entries in the temporal contextual dataset, such as recent news events or seasonal shifts, and updates the cached suggestions accordingly.

In some embodiments, the system applies a stopword removal process to the datasets before generating keyword suggestions. Stopwords are commonly used terms, such as “the,” “and,” or “is,” that do not add significant meaning to a search query and are often irrelevant for predictive purposes. The system identifies and filters out these stopwords from the datasets to focus on more meaningful keywords. By removing these frequently occurring but low-value terms, the system improves the relevance and quality of the keyword suggestions, ensuring that the generated completions are based on words that contribute to the user's search intent.

In some embodiments, the system generates keyword suggestions in multiple languages, with the language selection based on the user's input language setting. The system can access datasets containing keywords in various languages and use the specified language setting to determine which dataset to prioritize for suggestions. For example, if the user has selected French as the input language, the system will generate keyword suggestions from French language datasets. This ensures that the suggestions are contextually and linguistically appropriate for the user's preferred language, allowing the system to support multilingual environments and provide relevant keyword completions based on the user's language choice.

At step 250, the system filters the keyword suggestions to remove duplicates, and limits the number of suggestions to a predefined maximum number. In this context, filtering refers to the process of refining the list of suggestions by eliminating repeated or redundant entries. Duplicates may occur when the same keyword is suggested by multiple datasets or when variations of the same keyword are generated by the system. For example, if the temporal contextual dataset and the statistical n-gram dataset both suggest “electric” as a keyword, the filtering step ensures that only one instance of “electric” remains in the final list. This step helps maintain the accuracy and cleanliness of the output by preventing unnecessary repetition.

In some embodiments, once the duplicates are removed, the system proceeds to limit the total number of keyword suggestions to a predefined maximum number. This predefined limit is a predetermined threshold that specifies the maximum number of keyword suggestions that can be displayed to the user at any given time. The limit is typically set based on user interface constraints or processing considerations. For instance, the system may be configured to display no more than 10 or 20 keyword suggestions in the search interface to avoid overwhelming the user with too many options. The system ensures that the final list of suggestions adheres to this predefined limit by truncating any additional entries beyond the specified number.

The process of limiting the number of keyword suggestions involves selecting only the highest-ranking suggestions based on the weighted interpolation performed in step 240. Once the duplicates have been removed, the system evaluates the remaining suggestions and selects the most relevant ones for inclusion in the final list. The selection process is based on the ranking established during the interpolation phase, where suggestions generated from datasets with higher weights and stronger matches to the search prefix are prioritized. Any lower-ranked suggestions that exceed the predefined limit are discarded to ensure that only the most relevant completions are presented to the user.

At step 260, the system displays the keyword suggestions to the user in real-time or near-real-time as the search prefix is being entered. The system renders the list of keyword suggestions on the user's device or interface, allowing the user to view and interact with the suggested completions as they type. This display occurs through the search interface, which may be, e.g., a search bar, text input field, or any other user interface component that accepts text input. The display is updated dynamically as the user continues to enter characters, ensuring that the keyword suggestions remain relevant to the evolving search prefix.

In some embodiments, the system's real-time or near-real-time display is facilitated by a continuous communication loop between the user interface and the processing system. As each character is entered by the user, the search prefix is updated, and the system simultaneously processes this input to generate an updated set of keyword suggestions. These suggestions are then transmitted back to the search interface and rendered immediately. This real-time or near-real-time interaction allows the user to see relevant suggestions as they type, providing them with immediate feedback and potential completions for their query. In some embodiments, the display process occurs such that there is minimal latency between the user's input and the system's response.

In some embodiments, the keyword suggestions may be displayed in a dropdown menu or list beneath the search interface, depending on the design of the application or device being used. The layout of this list is often structured so that the highest-ranked keyword suggestions, based on the system's interpolation and ranking process, appear at the top. The user can select a suggestion from the list by interacting with the interface, either by clicking or tapping on a suggestion or by using keyboard shortcuts to navigate through the options. This interactive display mechanism ensures that the user has easy access to the most relevant keyword completions without needing to type the entire query manually.

In some embodiments, the display is continuously refreshed as the user types additional characters or modifies the search prefix. Each new input triggers the system to update the keyword suggestions in real-time or near-real-time, replacing the previously displayed list with a new set of suggestions that match the latest input. This dynamic updating process allows the system to adapt to the user's changing intent, ensuring that the displayed keyword suggestions are always aligned with the most recent search prefix. This real-time or near-real-time feedback mechanism enhances the fluidity of the user's interaction with the system, allowing for a seamless and responsive search experience.

In some embodiments, the system determines a success rate for each keyword suggestion by evaluating whether a suggested keyword matches the final input entered by the user. The success rate is calculated by tracking how often a suggested keyword is selected or matches the final query completed by the user. The system uses this data to refine the weighting of the datasets in future predictions. For example, if suggestions from the temporal contextual dataset frequently lead to successful matches, the system may increase the weight assigned to this dataset in subsequent searches. Conversely, datasets with lower success rates may have their weights reduced.

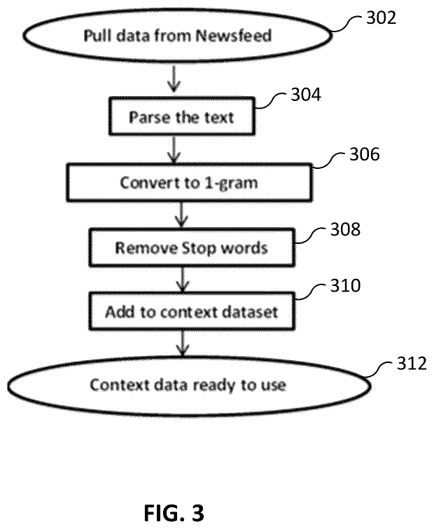

FIG. 3 is a flowchart illustrating an example process for generating contextual data, in accordance with some embodiments. Specifically, the flowchart depicts a process for generating contextual data from a real-time or near-real-time news feed, to be utilized in the temporal contextual dataset. The process includes a set of sequential steps that transform raw data into a structured format, suitable for enhancing keyword prediction. Each step contributes to refining the raw input into meaningful data that can effectively support the prediction algorithms.

The first step (302) in the flowchart involves pulling data from a newsfeed. This newsfeed is typically an RSS feed, which provides structured updates from various news sources. This step ensures that the system receives the latest news content, reflecting current events that are highly relevant for generating up-to-date contextual data. The RSS feed may include article titles, summaries, and other metadata, which serve as the raw material for further processing.

Once the newsfeed data is pulled, the system proceeds to parse the text (304). Parsing involves analyzing the structured format of the RSS feed to extract key components, such as article titles, descriptions, and other meaningful text content. The parsing step breaks down the incoming data into manageable segments, isolating words and phrases that are likely to be relevant for keyword prediction. This ensures that only the necessary and informative components of the news feed are retained for the next stages.

Following parsing, the extracted text is then converted to 1-gram (306). In this context, a 1-gram refers to individual words derived from the parsed text. By breaking down the parsed content into single-word units, the system prepares the data for efficient use in the prediction algorithms. For example, a headline like “Electric Car Sales Surge” would be broken down into individual terms: “Electric,” “Car,” “Sales,” and “Surge.” This step ensures that the dataset captures granular information, which is crucial for generating relevant keyword suggestions.

The next step involves removing stop words (308). Stop words are common words such as “the,” “and,” “is,” or “of,” which typically do not carry significant meaning for search purposes. The system filters out these stop words to focus on more meaningful words that contribute to the context of the news content. By eliminating these low-value words, the dataset becomes more refined, consisting of only the keywords that have the potential to improve the relevance of user search predictions.

Once the stop words are removed, the filtered keywords are added to the context dataset (310). This dataset forms part of the temporal contextual dataset used by the system for predicting user queries. By continuously updating the context dataset with new, relevant keywords extracted from the newsfeed, the system maintains a current set of data that reflects the latest trends and events. This real-time or near-real-time aspect helps ensure that users receive suggestions that are aligned with ongoing news and seasonal occurrences.

The final step (312) in the flowchart marks the readiness of the context data. Specifically, the context data is now ready to be used in the keyword prediction process. The refined dataset, consisting of parsed, tokenized, and stop-word-filtered 1-gram keywords, is now integrated into the temporal contextual dataset. This enriched dataset allows the system to provide keyword suggestions that are contextually relevant and reflect the most current events, thereby improving the accuracy and usefulness of the keyword prediction.

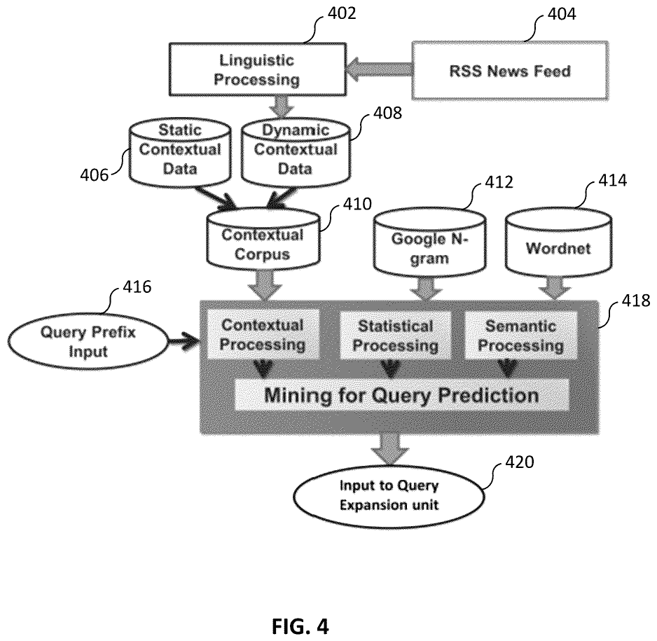

FIG. 4 illustrates an overview of an example process for context sensitive word prediction, in accordance with some embodiments. The process is involved in generating keyword suggestions for query prediction, involving multiple stages of data collection, processing, and mining. The figure depicts how various types of datasets—contextual, statistical, and semantic—are integrated to provide a comprehensive approach to predicting user search queries based on the initial prefix input. Each type of dataset undergoes specialized processing to enhance the accuracy and relevance of keyword suggestions generated by the system.

The process begins with data acquisition from two main sources: static contextual data (406) and dynamic contextual data (408). Dynamic contextual data is derived from an RSS news feed (404) that undergoes linguistic processing (402) to extract relevant content. This processing involves analyzing and tokenizing the content of the news feed to identify key information that will be used in query prediction. Static contextual data, on the other hand, is pre-constructed and includes keywords related to specific occasions, seasons, and general usage patterns that are less subject to rapid changes. Both types of contextual data are combined into a contextual corpus (410), forming a dataset that captures both static and dynamic contexts relevant to user searches.

Alongside the contextual corpus, FIG. 4 shows the use of external data sources, specifically a statistical n-gram dataset (412) and a semantic dataset (414). The n-gram dataset is built by analyzing the co-occurrence of words across a corpus of text, enabling the system to predict common patterns and relationships between words. The semantic dataset, represented by WordNet, provides relationships between words, such as synonyms, antonyms, and lexical hierarchies. These different data sources are treated independently but ultimately converge during the mining process for keyword prediction (418).

The query prediction mechanism itself takes as input a search prefix entered by the user (416). This prefix is processed across three distinct modules: contextual processing, statistical processing, and semantic processing. Each module corresponds to one of the main datasets. Contextual processing utilizes the contextual corpus (410) to find keywords that are relevant to the current time and season. Statistical processing uses the n-gram dataset (412) to identify common word pairings and sequences that fit the given prefix. Semantic processing uses the relationships between words in the semantic dataset (414) to suggest synonyms or related terms. The outcomes of these processing modules are then integrated into the “Mining for Query Prediction” unit (418), which compiles the final set of keyword suggestions. These suggestions are subsequently provided as input to the query expansion unit (420), which further enhances the predictive capabilities of the system.

This depicted process allows the system to generate keyword predictions that are not only based on frequently used terms and linguistic relationships but are also dynamically contextualized to reflect the latest news and current events. By utilizing multiple forms of data, the system ensures that keyword suggestions are accurate, contextually relevant, and responsive to user intent, based on the evolving nature of the data.

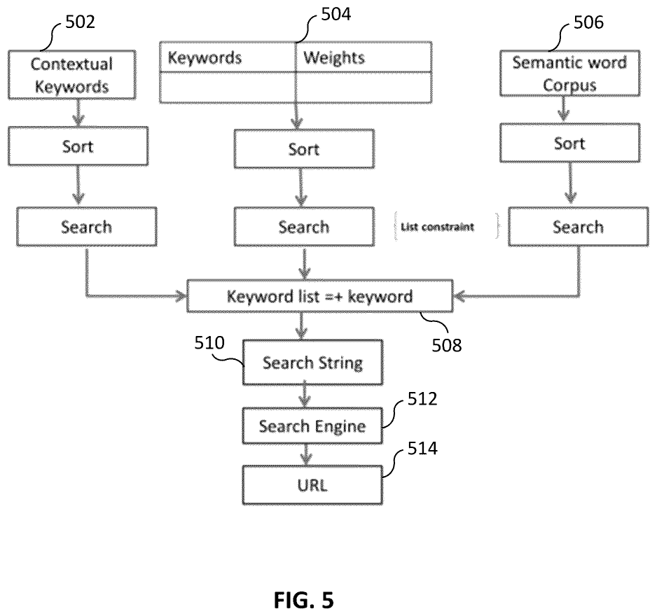

FIG. 5 illustrates an example process for mining keywords from corpora, in accordance with some embodiments. three distinct corpora—contextual keywords, weighted keyword lists, and a semantic word corpus—to generate a search string and subsequently produce a URL for querying a search engine. The figure represents how these three types of datasets are independently sorted, searched, and combined into a comprehensive keyword list before being used to formulate a query string.

The process begins with three different datasets: contextual keywords (502), weighted keywords (504), and a semantic word corpus (506). Each dataset is processed independently in its respective branch. For contextual keywords (502), the data undergoes a sorting operation to organize the keywords based on predefined criteria, which could include factors like frequency of occurrence or relevance. Following the sorting step, a search is performed within the contextual keywords dataset to identify words that match the current query prefix. The contextual keywords represent terms that are extracted from dynamic content such as news feeds or static content based on seasonal or topical contexts.

The weighted keyword list (504) includes a dataset with assigned weights, which indicate the relative importance of each keyword. Similar to the contextual dataset, the keywords undergo a sorting operation, where they are ordered based on their assigned weights. After sorting, the dataset is searched to extract relevant keywords that meet a specified list constraint. The list constraint ensures that only a limited number of top-weighted keywords are selected for further processing. This process helps prioritize keywords that have a higher probability of being useful to the user based on past interactions or contextual relevance.

The semantic word corpus (506) includes words organized based on their semantic relationships, such as synonyms, antonyms, or words related by meaning. This dataset is also sorted and then searched for keywords that relate semantically to the user's query prefix. This enables the system to generate suggestions that provide alternative or related terms that the user might be interested in.

After the keywords are independently sorted and searched, the system combines the results from each dataset into a unified keyword list (508). This combined keyword list represents an amalgamation of terms from the contextual, weighted, and semantic datasets, giving a diverse yet focused set of suggestions. The keywords in this list are used to formulate a search string (510), which is an expanded version of the user's original query prefix. This search string is then passed to the search engine (512), which processes the expanded query to retrieve relevant results. The search engine subsequently produces a URL (514), which directs the user to a page containing results based on the expanded query string.

Overall, FIG. 5 illustrates how keywords are mined from multiple datasets—contextual, weighted, and semantic—and are processed through sorting, searching, and combining to formulate a comprehensive search string. By integrating these distinct datasets, the system is capable of generating a richer and more contextually aware search query, which helps produce relevant results that align more closely with the user's search intent.

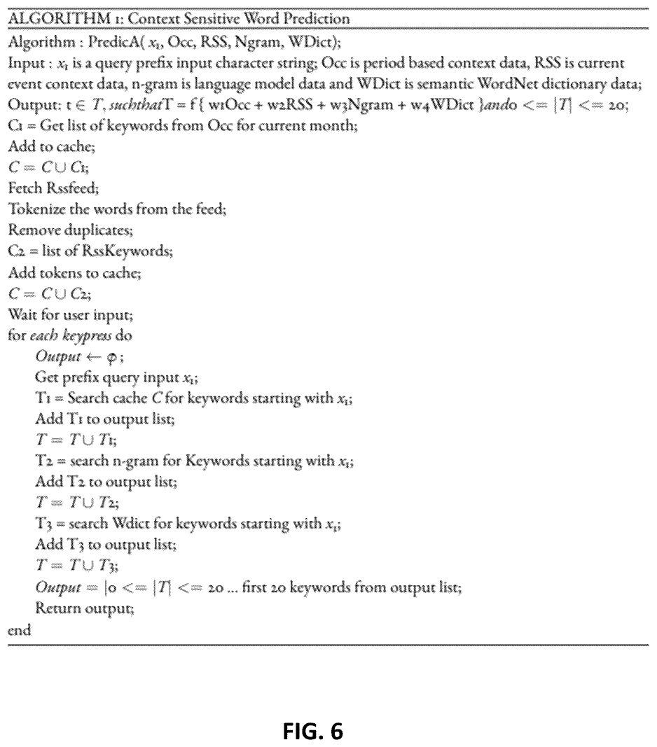

FIG. 6 presents an example process for context-sensitive word prediction, in accordance with some embodiments. The process uses various types of datasets to predict likely completions for a user-provided search prefix. The process takes input from a query prefix (x1), which represents the partial search string entered by the user and uses several data sources to generate keyword suggestions. These datasets include period-based context data (Occ), current event context data obtained from an RSS feed (RSS), language model data derived from an n-gram corpus (Ngram), and semantic dictionary data (WDict).

The algorithm starts by fetching relevant keywords based on temporal context, such as period-based keywords for the current month (Occ). The fetched data is then tokenized, filtered to remove duplicates, and added to the cache. This cached data forms the basis for efficient keyword lookups as the user continues to type. The system waits for user input, and each time a key is pressed, the algorithm searches through the cache for keywords that match the current prefix.

For each user keystroke, the system first searches the cache (C) for keywords that start with the provided prefix (x1). It then adds these matches to an output list (T). Following this, the algorithm searches the n-gram dataset (Ngram) for additional matches, which are subsequently added to the output list. Lastly, it searches the semantic dictionary (WDict) for more relevant keywords, which are also appended to the output list.

The final output consists of a list of keywords (T), constrained to the first 20 keywords that are most relevant to the given prefix. The result is returned to the user as a list of keyword suggestions that are contextually appropriate, based on dynamic current events, historical context, and semantic relationships between words. The caching mechanism helps in accelerating the lookup process, ensuring that users receive suggestions in near-real-time as they type.

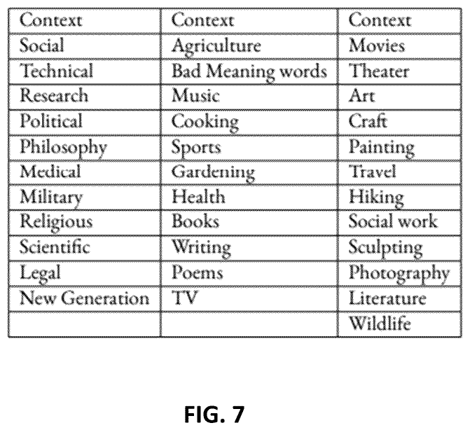

FIG. 7 depicts a context taxonomy that categorizes various thematic areas in which keywords can be classified, in accordance with some embodiments. This taxonomy assists in understanding how a specific keyword may have different meanings or implications depending on the context in which it appears. The taxonomy includes a broad range of categories such as social, technical, political, medical, and scientific, among others. Each context represents a distinct subject area that can influence the interpretation of a keyword, helping the system to determine its meaning based on contextual associations.

For instance, a keyword like “draft” might have different meanings under different categories—such as “military,” where it could refer to compulsory enlistment, or “writing,” where it could indicate an initial version of a document. By categorizing keywords according to the appropriate context, the system can disambiguate user inputs and generate more relevant suggestions during search. Keywords related to categories such as agriculture, music, sports, movies, health, and art can further vary significantly in terms of usage and relevance depending on the user's current search intent.

The classification into contexts also includes more specific and diverse categories like social work, gardening, travel, and theater, which further enrich the system's ability to understand nuanced user input. The context taxonomy allows the system to incorporate semantic meaning into the prediction process, enabling more accurate and personalized keyword suggestions based on the context most relevant to the user. For example, a search query for “field” could be interpreted differently if it is associated with “sports,” where it refers to a playing field, or with “agriculture,” where it refers to a cultivated area.

This context taxonomy enables the system to manage diverse topics in a structured way, leveraging different types of context data to better interpret ambiguous keywords. This structure is particularly useful for generating accurate keyword predictions, as the system can focus on the most probable context based on user behavior, input history, or explicit contextual indicators provided by the user during a search.

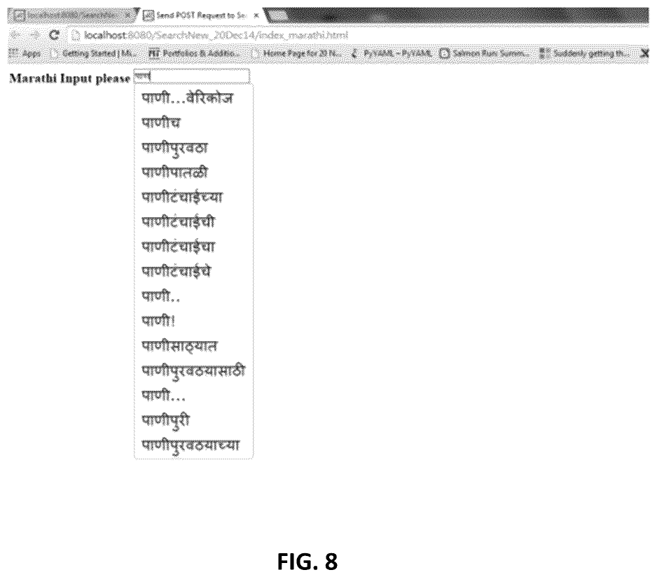

FIG. 8 illustrates an example of the autocomplete feature generated by the context-sensitive word prediction process, in accordance with some embodiments. The figure shows a user interface where a user begins typing a word in the Marathi language, and the system dynamically provides a list of suggested completions. These suggestions are generated using the context-sensitive algorithms discussed previously, which consider a variety of factors including the search prefix entered by the user, the contextual dataset, recent events, and linguistic relationships between words.

In the example depicted, as the user starts typing a prefix in Marathi, the system generates multiple possible word completions based on that prefix. The suggestions are presented in a dropdown list, providing the user with options that they can select to complete their query with fewer keystrokes. The list contains different variations and forms of the prefix, reflecting the dynamic and contextually relevant nature of the system's word prediction capability.

This autocomplete feature enhances user interaction by providing real-time or near-real-time assistance and reducing the typing burden, particularly when dealing with complex or lengthy words. The context-sensitive approach takes into account not just the prefix but also the linguistic structure of Marathi, which involves dealing with grammatical nuances, suffixes, and various word inflections. As seen in FIG. 8, the suggestions include different forms of the word “ [symbol] ” (which means “water” in Marathi) and various suffixes that relate to different contexts or grammatical constructions.

The display of these word completions highlights the effectiveness of the prediction model in supporting languages with complex scripts, such as Marathi. By dynamically updating the suggestions as the user types, the system provides an efficient way for users to complete their intended words or phrases, enhancing both speed and accuracy in text input. This feature is especially useful for applications like search engines or text editors, where rapid and accurate input is essential.

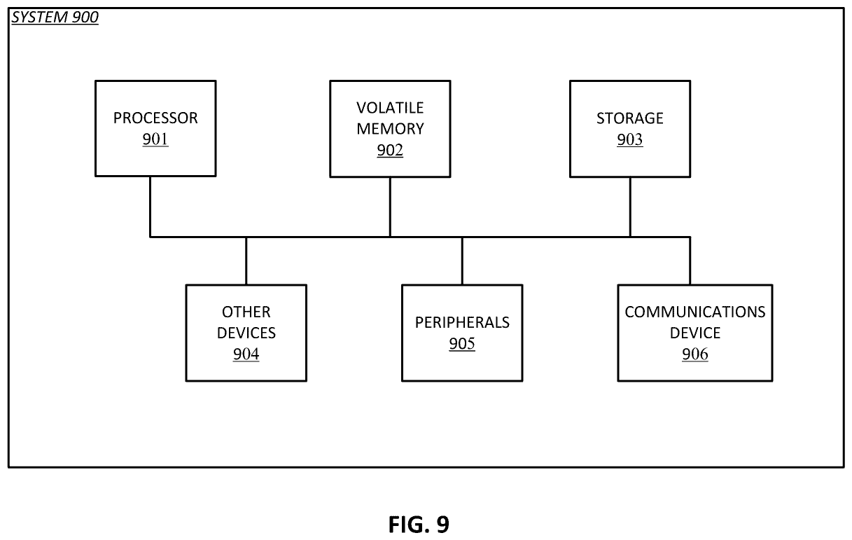

FIG. 9 is a diagram illustrating an exemplary computer that may perform processing in some embodiments. Exemplary computer 900 may perform operations consistent with some embodiments. The architecture of computer 900 is exemplary. Computers can be implemented in a variety of other ways. A wide variety of computers can be used in accordance with the embodiments herein.

Processor 901 may perform computing functions such as running computer programs. The volatile memory 902 may provide temporary storage of data for the processor 901. RAM is one kind of volatile memory. Volatile memory typically requires power to maintain its stored information. Storage 903 provides computer storage for data, instructions, and/or arbitrary information. Non-volatile memory, which can preserve data even when not powered and including disks and flash memory, is an example of storage. Storage 903 may be organized as a file system, database, or in other ways. Data, instructions, and information may be loaded from storage 903 into volatile memory 902 for processing by the processor 901.

The computer 900 may include peripherals 905. Peripherals 905 may include input peripherals such as a keyboard, mouse, trackball, video camera, microphone, and other input devices. Peripherals 905 may also include output devices such as a display. Peripherals 905 may include removable media devices such as CD-R and DVD-R recorders/players. Communications device 906 may connect the computer 100 to an external medium. For example, communications device 906 may take the form of a network adapter that provides communications to a network. A computer 900 may also include a variety of other devices 904. The various components of the computer 900 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure is, accordingly, to be regarded in an illustrative sense rather than a restrictive sense.

What is claimed is:

1. A computer-implemented method for predicting word completions in response to partial input, the method comprising:
receiving, at a processing system, a search prefix entered by a user in a search interface;
searching a plurality of datasets for keywords that match the search prefix, wherein the plurality of datasets comprises:
a temporal contextual dataset comprising dynamic data related to current events and season-based keyword data,
a statistical n-gram dataset comprising n-gram keywords, and
a semantic dataset comprising lexical and semantic relationships between words;
assigning a weight to each of the datasets based on a predefined hierarchy, wherein the temporal contextual dataset is assigned a higher weight than the statistical n-gram dataset and the semantic dataset;
generating a list of keyword suggestions based on the search prefix by interpolating results from the plurality of datasets according to the assigned weights;
filtering the keyword suggestions to remove duplicates and limiting the number of suggestions to a predefined maximum number; and
displaying the keyword suggestions to the user in real-time or near-real-time as the search prefix is being entered.

2. The method of claim 1, wherein the temporal contextual dataset further comprises a real-time or near-real-time news feed parsed and tokenized from an RSS feed.

3. The method of claim 1, wherein the temporal contextual dataset further comprises keywords related to specific occasions associated with a current calendar period.

4. The method of claim 1, further comprising:
caching the keyword suggestions for quicker retrieval in response to subsequent keypresses.

5. The method of claim 4, wherein the cached suggestions are updated periodically based on the changes in the temporal contextual dataset.

6. The method of claim 1, further comprising:
applying a stopword removal process to the datasets before generating the keyword suggestions, wherein stopwords comprise frequently used terms that do not add significant meaning.

7. The method of claim 1, wherein the weight assigned to each dataset is dynamically adjusted based on a user-specific context comprising one or more of: a location, language, or search history of the user.

8. The method of claim 1, wherein the keyword suggestions are presented in a ranked order based on the relevance of each suggestion to the temporal context.

9. The method of claim 1, further comprising:
determining a success rate for each keyword suggestion based on whether a suggested keyword matches a final user input; and
using the success rate to adjust the future weighting of the datasets.

10. The method of claim 1, wherein the keyword suggestions are generated in multiple languages, and a selection of a language for the keyword suggestions is based on an input language setting for the user.

11. A system comprising:
one or more processors; and
memory storing instructions that, when executed by the one or more processors, cause the system to perform operations comprising:
receiving, at a processing system, a search prefix entered by a user in a search interface;
searching a plurality of datasets for keywords that match the search prefix, wherein the plurality of datasets comprises:
a temporal contextual dataset comprising dynamic data related to current events and season-based keyword data,
a statistical n-gram dataset comprising n-gram keywords, and
a semantic dataset comprising lexical and semantic relationships between words;
assigning a weight to each of the datasets based on a predefined hierarchy, wherein the temporal contextual dataset is assigned a higher weight than the statistical n-gram dataset and the semantic dataset;
generating a list of keyword suggestions based on the search prefix by interpolating results from the plurality of datasets according to the assigned weights;
filtering the keyword suggestions to remove duplicates and limiting the number of suggestions to a predefined maximum number; and
displaying the keyword suggestions to the user in real-time or near-real-time as the search prefix is being entered.

12. The system of claim 11, wherein the temporal contextual dataset further comprises a real-time or near-real-time news feed parsed and tokenized from an RSS feed.

13. The system of claim 11, wherein the temporal contextual dataset further comprises keywords related to specific occasions associated with a current calendar period.

14. The system of claim 11, wherein the instructions cause the system to further perform an operation comprising:
caching the keyword suggestions for quicker retrieval in response to subsequent keypresses.

15. The system of claim 14, wherein the cached suggestions are updated periodically based on the changes in the temporal contextual dataset.

16. The system of claim 11, wherein the instructions cause the system to further perform an operation comprising:
applying a stopword removal process to the datasets before generating the keyword suggestions, wherein stopwords comprise frequently used terms that do not add significant meaning.

17. The system of claim 11, wherein the weight assigned to each dataset is dynamically adjusted based on a user-specific context comprising one or more of: a location, language, or search history of the user.

18. The system of claim 11, wherein the keyword suggestions are presented in a ranked order based on the relevance of each suggestion to the temporal context.

19. The system of claim 11, wherein the instructions cause the system to further perform operations comprising:
determining a success rate for each keyword suggestion based on whether a suggested keyword matches a final user input; and
using the success rate to adjust the future weighting of the datasets.

20. A non-transitory computer-readable medium containing instructions comprising:
receiving, at a processing system, a search prefix entered by a user in a search interface;
searching a plurality of datasets for keywords that match the search prefix, wherein the plurality of datasets comprises:
a temporal contextual dataset comprising dynamic data related to current events and season-based keyword data,
a statistical n-gram dataset comprising n-gram keywords, and
a semantic dataset comprising lexical and semantic relationships between words;
assigning a weight to each of the datasets based on a predefined hierarchy, wherein the temporal contextual dataset is assigned a higher weight than the statistical n-gram dataset and the semantic dataset;
generating a list of keyword suggestions based on the search prefix by interpolating results from the plurality of datasets according to the assigned weights;
filtering the keyword suggestions to remove duplicates and limiting the number of suggestions to a predefined maximum number; and
displaying the keyword suggestions to the user in real-time or near-real-time as the search prefix is being entered.
